(19) United States
(12) Patent Application Publication
(10) Pub. No.: US 2008/0312995 A1
(43) Pub. Date: Dec. 18, 2008

(54) METHODS AND APPARATUS FOR MANAGING SYSTEM EVENTS

(75) Inventors: Adriaan Van Wyk, Strubensvalley (ZA); Lardus Brooks, Pretoria (ZA)

Correspondence Address: BELL, BOYD & LLOYD, LLP, P.O. Box 1135, CHICAGO, IL, 60690, US

(73) Assignee: SOURCECODE TECHNOLOGY HOLDING, INC., Redmond, WA (US)

(21) Appl. No.: 12/054,259

(22) Filed: Mar. 24, 2008

Related U.S. Application Data
(60) Provisional application No. 60/939,279, filed on May 21, 2007.
(60) Provisional application No. 60/896,730, filed on Mar. 23, 2007.

(51) Int. Cl. G06Q 10/00

(52) U.S. Cl. 705/7

(57) ABSTRACT

The present disclosure provides methods and apparatuses for managing system events. Using the methods and apparatus herein, users can create events that are based on changes in a business process or a business system due to a business process activity. Users can create and manage events that evaluate and execute policies outside of the context of the business process workflow and policy management systems.

### CROSS-REFERENCE TO RELATED APPLICATIONS

The present application claim benefit to U.S. Patent Application No. 60/896,730, METHOD AND APPARATUS FOR DESIGNING WORK FLOWS, filed on Mar. 23, 2007; and U.S. Patent Application No. 60/939,279, METHODS AND APPARATUS FOR MANAGING WORKFLOW EVENTS, filed on May 21, 2007, the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Business can now also incorporate business process design into their existing technology systems. Instead of providing a simple map of a business process, integration with computer systems allows business process designers to design interactive business processes that drive business workflow. Business process designers can receive data from various sources and perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Business processes have a defined workflow and new actions that have to be performed usually must be included in a redesigned business process. Redesigning the process every time a new function is to be performed may be time consuming. Additionally, a business process may perform an action that triggers a number of optional sub-actions, unrelated to the main business process. Reconfiguring the business process for each scenario or creating a large number of nearly identical business processes could be costly and time consuming as well.

Some business process software allows certain data to be monitored, so that events may be triggered by changes in the data. However, those software systems require the event logic to be coded into the data source, such as directly into the database system. The hard coding of the event logic makes it difficult for a non-technical user to change the event logic or to understand what events are being monitored. Additionally, such systems require an external process to periodically poll the data source to look for changes that would trigger an event. The polling requires substantial processing time if the polling is done frequently, or an event may not be triggered quickly enough if the polling time is set to a longer time period. Also, the systems may require administrator level access to add or alter event logic, which adds to the difficulty for a standard business user to configure the system.

### SUMMARY

The present disclosure provides methods and apparatuses for managing system events. Using the methods and apparatus herein, users can create events that are based on changes in a business process or a business system due to a business process activity. Users can create and manage events that evaluate and execute policies outside of the context of the business process workflow and policy management systems.

Additionally, using the methods and apparatus of the present disclosure, users can create events that are triggered as a result of periodic polling of the stored data.

Additional features and advantages are described herein, and will be apparent from, the following Detailed Description and the figures.

### BRIEF DESCRIPTION OF THE FIGURES

FIG. 1 is a high level block diagram of an example system event system.

FIG. 2 is a more detailed block diagram showing one example of a client device.

FIG. 3 is a more detailed block diagram showing one example of a server.

FIG. 4 is a screenshot of an example event management system.

FIG. 5 is a screenshot of an example event selection screen.

FIG. 6 is a screenshot of an example event data screen.

FIG. 7 is a screenshot of an example add condition screen.

FIG. 8 is a screenshot of an example add policy screen.

FIG. 9 is a screenshot of a example data mapping screen.

FIG. 10 is a screenshot of another example data mapping screen.

FIG. 11 is a screenshot of an exception selection screen.

### DETAILED DESCRIPTION

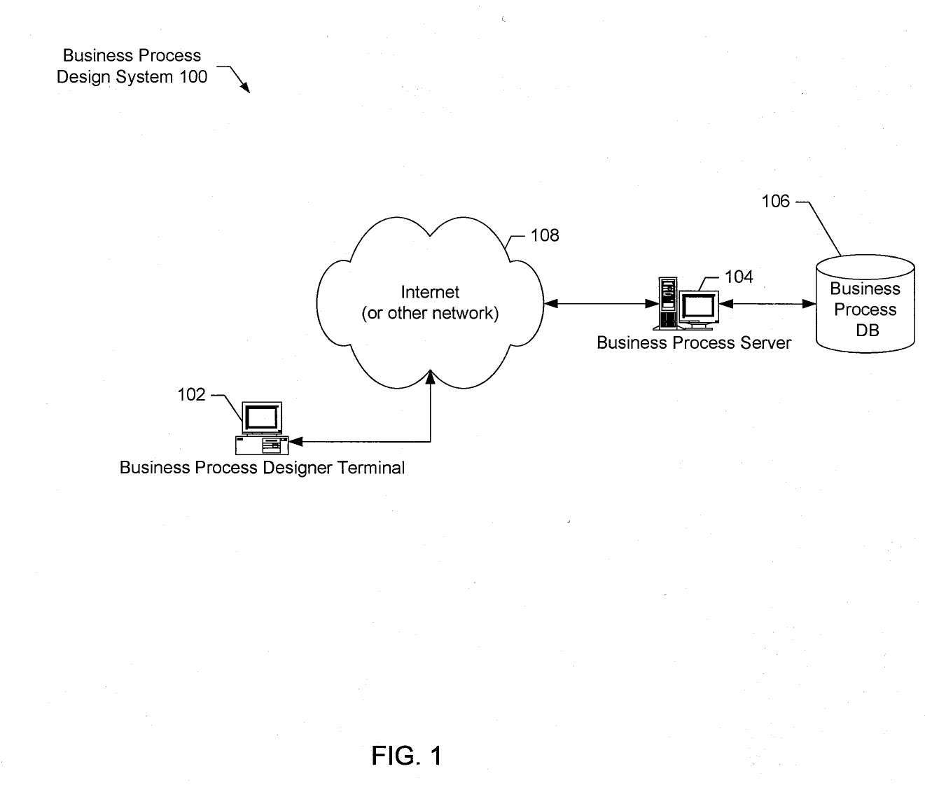

The present system is most readily realized in a network communications system. A high level block diagram of an exemplary network communications system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Additionally, the business process server 104 may be a plurality of business process servers. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

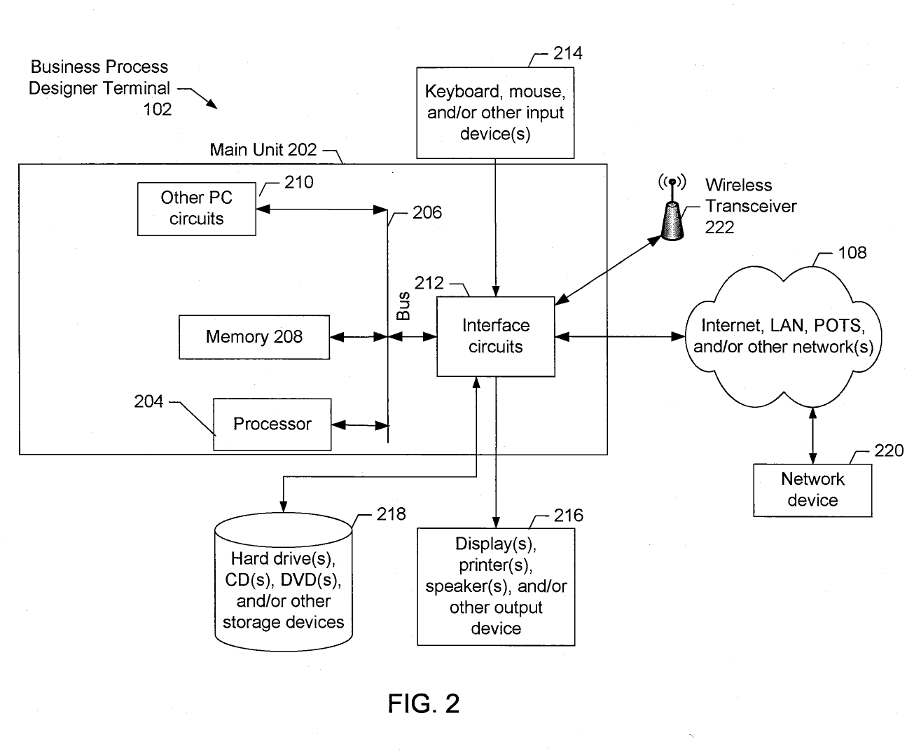

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

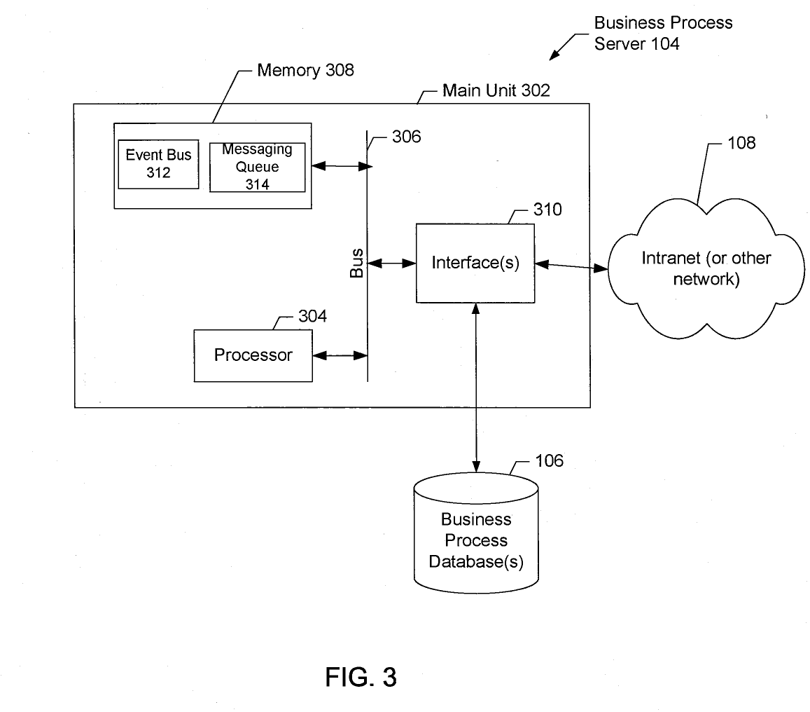

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

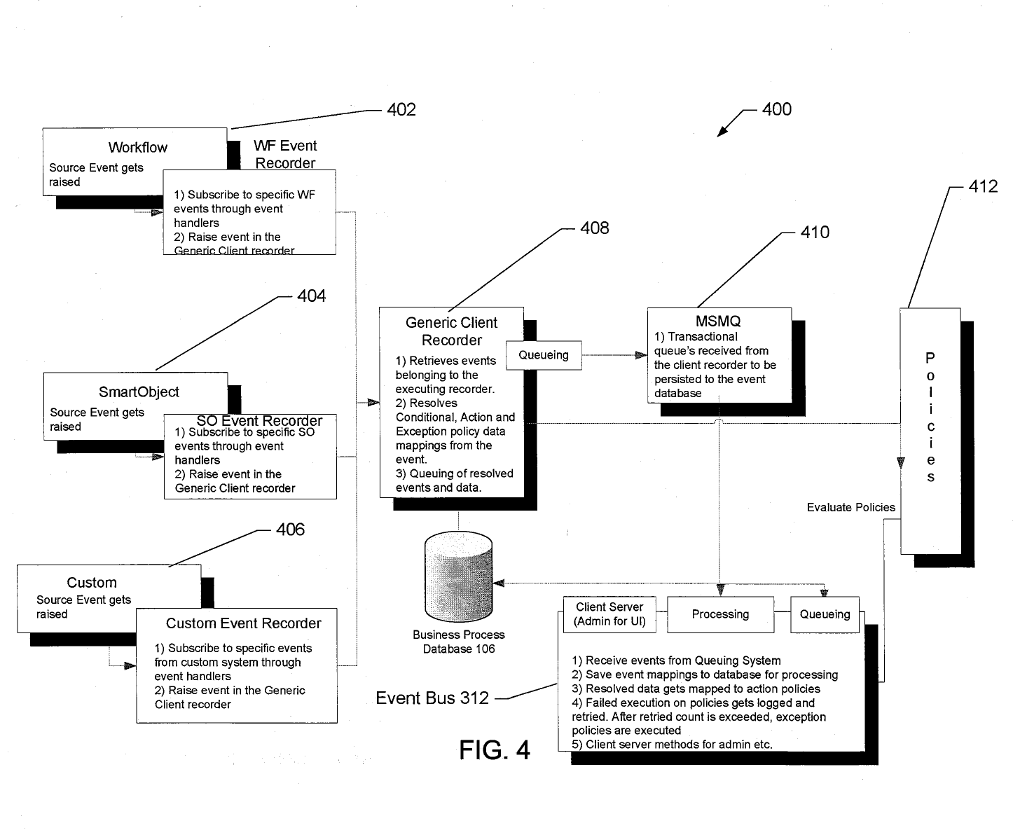

In particular, the memory 308 preferably stores an event bus 312 and a messaging queue 314. The event bus will be discussed in further detail in relation to FIG. 4. The messaging queue 314 will also be discussed in further detail in relation to FIG. 4.

A screenshot of an example event management system 400 is presented in FIG. 4. Although the example event management system 400 is described in reference FIG. 4, it will be appreciated that many other configurations are possible. For example, elements could be in different locations, elements could have different names, and elements could have different graphical representations.

The example event management system 400 may have a number of sources for the event to be triggered from. For example, the event management system 400 may have events created from workflow events 402, SmartObjects events 404, custom events 406 or scheduled events.

A workflow event 402 may be created in the normal design of a workflow process. For example, a workflow process designer may create a workflow in a workflow editor and include an “E-Mail Customer” event in the workflow process.

A SmartObject may be a specialized construct that abstracts data and provides a business process designer with a set of standardized functions to interact with the data. The SmartObject may have a set of associated events. For example, the SmartObject may have a create event, update event, delete event, etc. A business process designer can create custom events 406. The business process designer would need to implement a custom event recorder in order to properly interact with the generic client recorder 408.

A custom event 406 may be integrated with another business system and the customer event recorder may subscribe to specific events from a custom system through an event handler. For example, a custom event may be created for information retrieved from an external tax system. The custom event handler recorder may subscribe to an event of a rate in a tax table being updated.

A scheduled event may be one designed to be executed at a specific time. For example, a scheduled event may occur once a week.

The generic client recorder 408 may have a number of generic programming interfaces (APIs) for registering events, policies and message queue systems, allowing for customization of event systems. The generic client recorder 408 may also allow for any business system to be registered as part of the event management system, through the APIs. Once a system is registered, users can subscribe to events raised by that business system.

When the event occurs, the generic client recorder 408 may receive notice that the executing event occurred from the specific event recorders. For example, the executing event may be “New Customer,” and once the executing event occurs, the event recorder may raise the event in the generic client recorder 408.

The generic client recorder 408 may determine what type of policy or policies will be run based on the executed event. For example, the generic client recorder 408 may interrogate the policies storage 412, which may be stored on the business process database 106, to determine which policies are associated with the executed event. For example, the generic client recorder 408 may determine that a “Send Email” policy is associated with the “New Customer” event.

The policies may be of a conditional, action or exception type among others. A conditional policy may be a condition with a result in a true or false result. An action policy may merely perform an action without a true or false result. An exception policy may be used for error scenarios and be executed when certain error conditions are met. For example, a conditional policy may evaluate whether the “New Customer” name begins with an “A” and returns true or false. An action policy may be emailing a follow up email to a customer. An error policy may be to email a systems administrator with information regarding the executed event.

The policies are all independently created and managed in the policy management system 412. This allows a business to organize and manage the business policies independently of the usage of the policies. For example, a policy may be to email a user when the “New User” event is executed. If the business changed the policy to be to email a user and a customer representative, a business process designer only needs to access the policy instead of the entire new customer business process.

After resolving what type of policy is to be executed, the generic client recorder 408 may determine what data from the executed event is necessary for the policies. The generic client recorder 408 may place the event, policies, and data onto the messaging queue 410. The messaging queue 410 is an example messaging queue that may be implemented by messaging queue 314. Alternatively, the generic client recorder may place the policies and data onto the messaging queue 410.

The messaging queue 410 may be any software messaging service, including commercial products such as MSMQ, Biztalk, etc., or custom messaging solutions. The message queue 410 may work in an asynchronous, first in first out order. For example, the oldest event in the queue will be the first event that is taken off of the queue, and will not be dependent on the clock cycle.

The event bus 312 may receive the data and the policies from the message queue 314. The event bus 312 may also save the policy mappings to the database for processing. The event bus 312 may then map the data to the policy and process the policy. For example, the data may be “User Name” and the policy may be an email action policy. The “User Name” data may be mapped to the correct data field of the email action policy by the event bus 312.

If execution of the policy results in failure, the event bus 312 may retry to execute the policy and after a retry count is exceeded an exception policy may be executed. For example, if an email action policy fails three times, and the retry count is three, then an email administrator exception policy may be executed and an email detailing the error may be sent to a systems administrator.

The event bus 312 may also provide client server methods for administration. For example, the event bus 312 may provide the business designer terminal 102 with methods for administering the business process server 104.

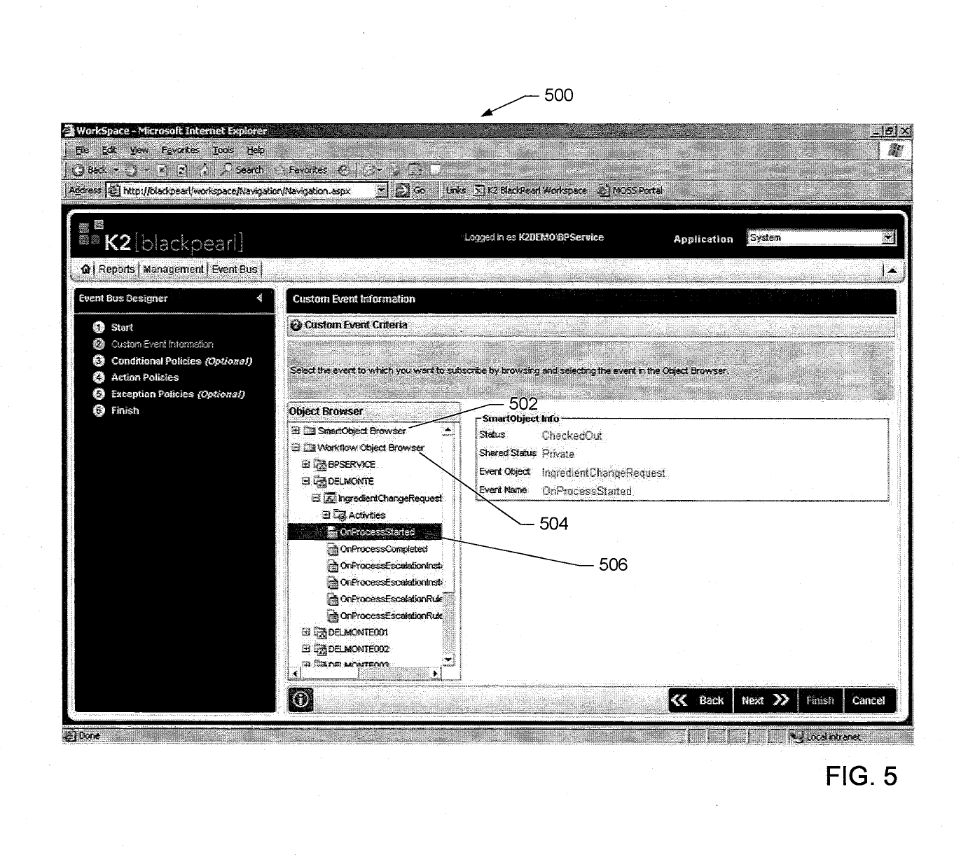

A screenshot of an example event selection screen 500 is presented in FIG. 5. Although the example event selection screen 500 is described in reference FIG. 5, it will be appreciated that many other configurations are possible. For example, elements could be in different locations, elements could have different names, and elements could have different graphical representations.

The event selection screen 500 may assist a user in setting up events to monitor. The event selection screen 500 may have a folder view area. The folder view area may have an object browser showing the different sources of objects. For example, a SmartObject browser 502 may correspond to a SmartObject Event source 404. A Workflow Object browser 504 may correspond to a workflow event source 402. The event selection screen 500 may allow the user to select a specific event 506 from an event source.

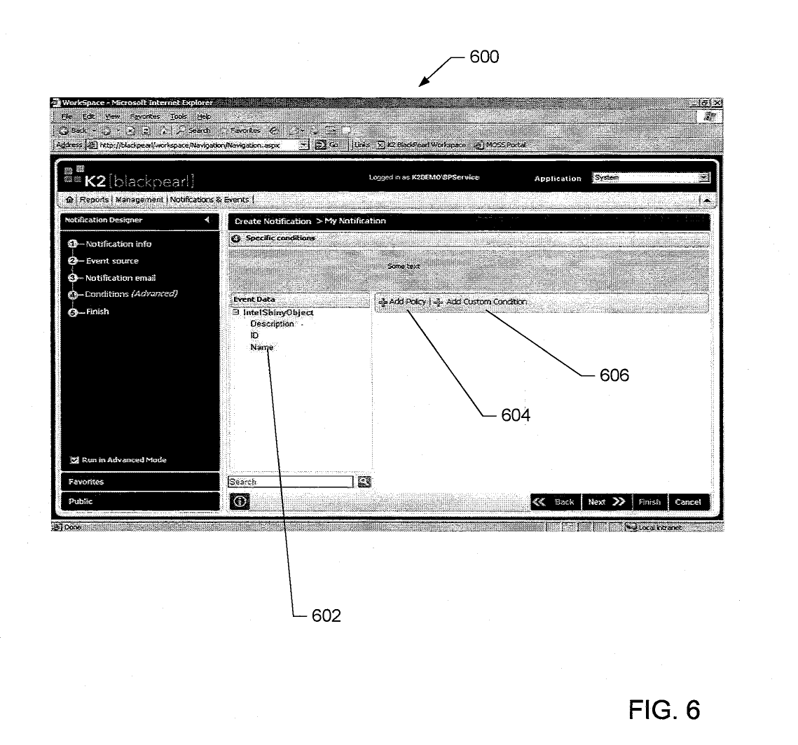

A screenshot of an example event data screen 600 is presented in FIG. 6. Although the example event data screen 600 is described in reference FIG. 6, it will be appreciated that many other configurations are possible. For example, elements could be in different locations, elements could have different names, and elements could have different graphical representations.

The user may be presented with an event data screen 600. For example, the business process server 104 may transmit the event data screen 600 to the business process designer terminal 102. The event data screen 600 may have an event data section 602, that shows the selected event's information. For example, the event data section 602 may include a description, id, name, etc. The event data screen 600 may also provide the user with options of adding a policy or a condition 606.

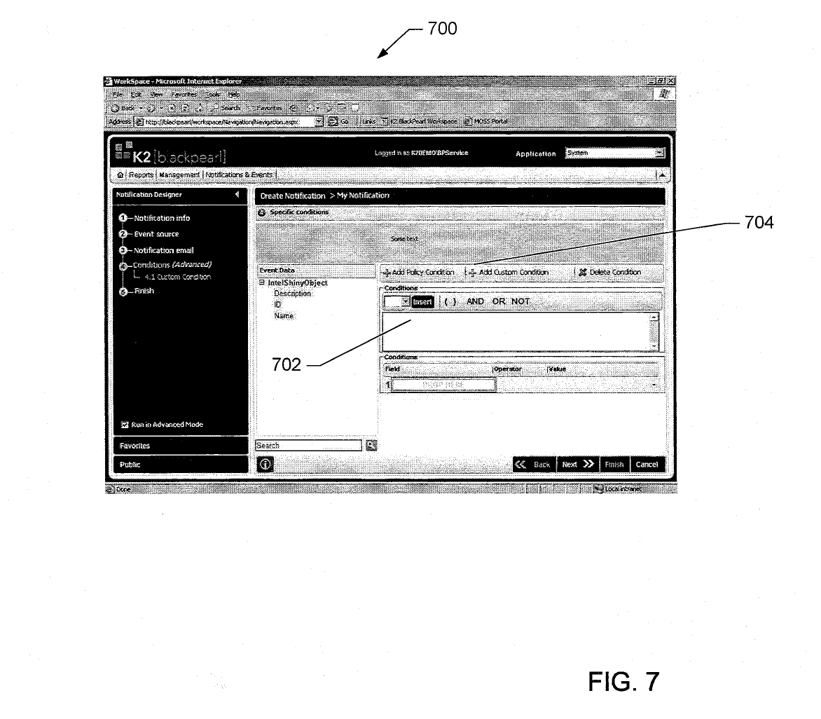

A screenshot of an example add condition screen 700 is presented in FIG. 7. Although the example add condition screen 700 is described in reference FIG. 7, it will be appreciated that many other configurations are possible. For example, elements could be in different locations, elements could have different names, and elements could have different graphical representations.

If the user selects to add a condition on the event data screen 600, the business process server 104 may transmit an add condition screen 700. The add condition screen 700 may provide a simple interface for adding logic for a policy. For example, a condition entry tool 702 may provide some common conditional logic 704 for a user to select from. The conditional logic 704 may include “and,” “or” and “not” operations.

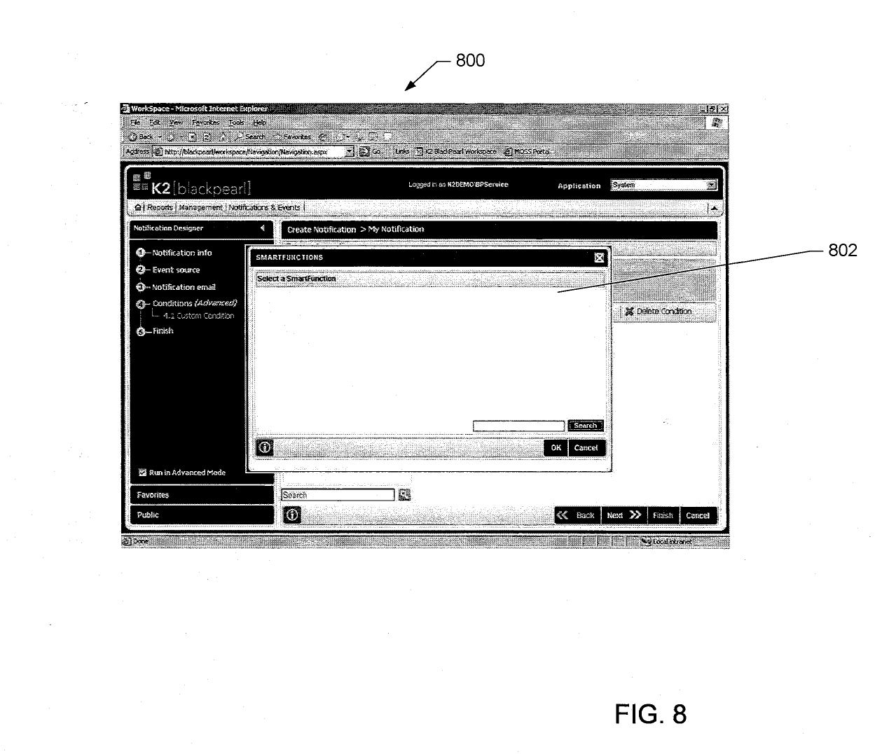

A screenshot of an example add policy screen 800 is presented in FIG. 8. Although the example add condition screen 800 is described in reference FIG. 8, it will be appreciated that many other configurations are possible. For example, elements could be in different locations, elements could have different names, and elements could have different graphical representations.

If the user chooses to add a policy from the event data screen 600, the user may be brought to the add policy screen 800. The add policy screen 800 may have a policy selection window 802. The policy selection window may allow the user to search for policies and select a desired policy or assist in creating a new policy.

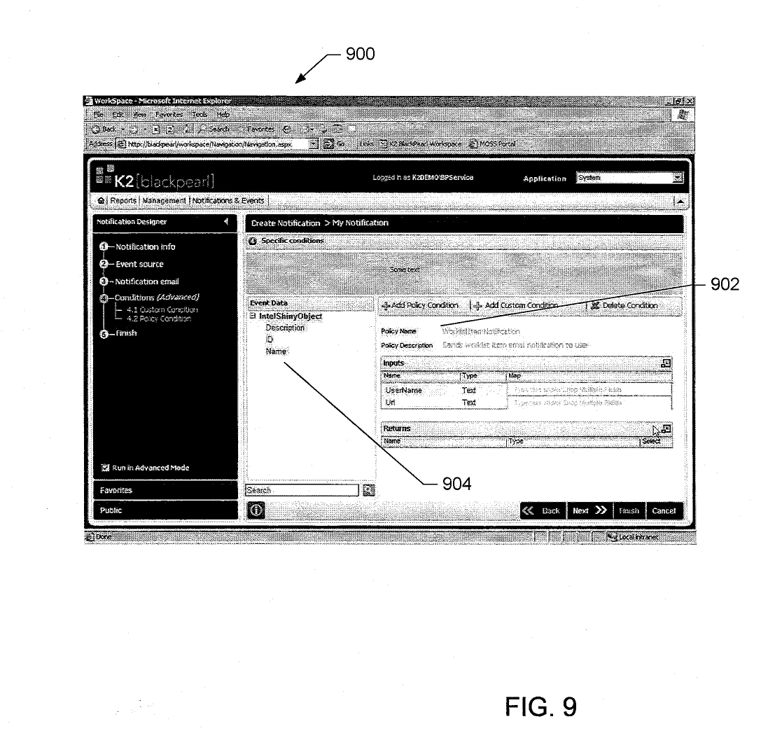

A screenshot of an example data mapping screen 900 is presented in FIG. 9. Although the example data mapping screen 900 is described in reference FIG. 9, it will be appreciated that many other configurations are possible. For example, elements could be in different locations, elements could have different names, and elements could have different graphical representations.

Once a policy is selected, the business process server 104 may transmit a data mapping screen 900. The data mapping screen 900 may display the data fields that the policy requires. The data mapping screen 900 may allow the user to map the data from the event to the policy. The data mapping screen 900 may have a data inputs section 902 displaying the required data. For example, an email user policy may have a “username” field to which the user can map an event's “new customer name” field. The user may drag and drop a field from the object browser 904 to the data inputs section 902.

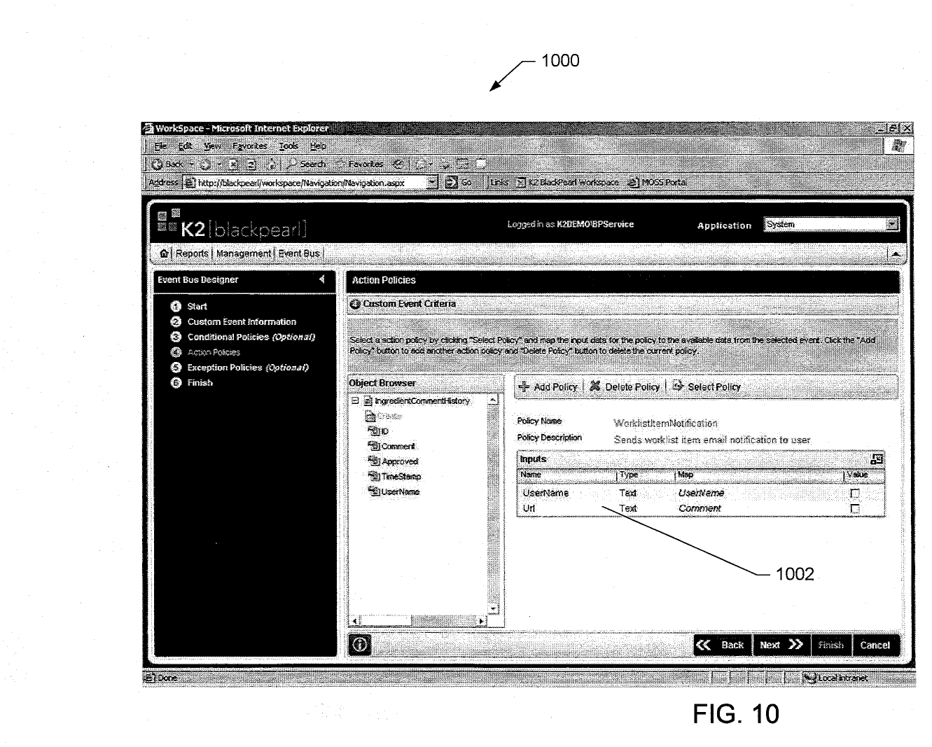

A screenshot of another example data mapping screen 1000 is presented in FIG. 10. Although the example data mapping screen 1000 is described in reference FIG. 10, it will be appreciated that many other configurations are possible. For example, elements could be in different locations, elements could have different names, and elements could have different graphical representations.

After selecting the fields to map from the event to the policy, the data mapping screen 1000 may display the finalized mapping 1002.

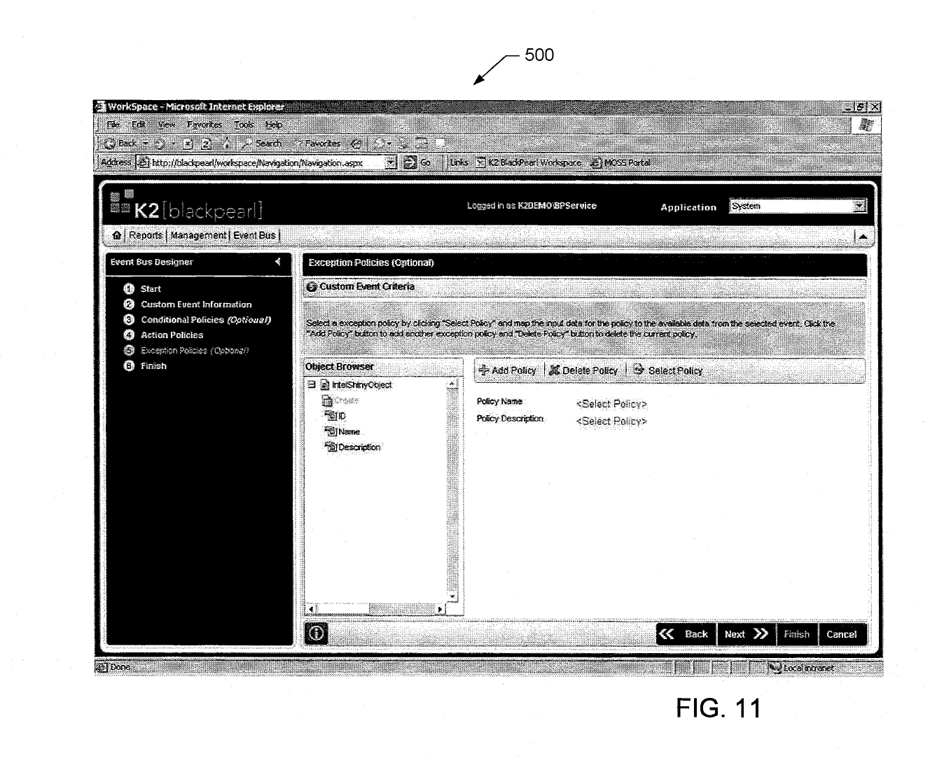

A screenshot of an exception selection screen 1100 is presented in FIG. 11. Although the example exception selection screen 1100 is described in reference FIG. 11, it will be appreciated that many other configurations are possible. For example, elements could be in different locations, elements could have different names, and elements could have different graphical representations.

After configuring a policy, the user may select an exception policy on the exception selection screen 1100. The exception selection screen 1100 allows the user to select an exception policy to run in the case of failure of the originally selected policy. For example, a user may wish to create or select a mail an administrator policy if the original policy fails to execute properly.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for managing system events, the method comprising:
creating an event, wherein the event includes event data;
recording the execution of the event;
retrieving a policy associated with the event;
determining a policy data from the event data;
entering the policy and the policy data into a management queue;
retrieving the policy and the policy data from the management queue; and
executing the policy based on the policy data.

2. The method of claim 1, wherein recording the execution of the event includes receiving an event execution notice from a custom system.

3. The method of claim 1, wherein the policy is one of the group comprising an action type, conditional type and exception type.

4. The method of claim 1, including receiving an execution response.

5. The method of claim 4, including executing an exception policy wherein the execution response is an exception response.

6. The method of claim 1, wherein the event is a scheduled event, wherein the scheduled event occurs at a predetermined time.

7. A system for managing system events, the system comprising:
a processor for:
creating an event, wherein the event includes event data;
recording the execution of the event;
retrieving a policy associated with the event;
determining a policy data from the event data;
entering the policy and the policy data into a management queue;
retrieving the policy and the policy data from the management queue; and
executing the policy based on the policy data.

8. The system of claim 7, wherein recording the execution of the event includes receiving an event execution notice from a custom system.

9. The system of claim 7, wherein the policy is one of the group comprising an action type, conditional type and exception type.

10. The system of claim 7, including receiving an execution response.

11. The system of claim 10, including executing an exception policy wherein the execution response is an exception response.

12. The system of claim 7, wherein the event is a scheduled event, wherein the scheduled event occurs at a predetermined time.

13. A computer readable medium storing instructions structured to cause a computing device to:
create an event, wherein the event includes event data;
record the execution of the event;
retrieve a policy associated with the event;
determine a policy data from the event data;
enter the policy and the policy data into a management queue;
retrieve the policy and the policy data from the management queue; and
execute the policy based on the policy data.

14. The computer readable medium of claim 13, wherein recording the execution of the event includes receiving an event execution notice from a custom system.

15. The computer readable medium of claim 13, wherein the policy is one of the group comprising an action type, conditional type and exception type.

16. The computer readable medium of claim 13, including receiving an execution response.

17. The computer readable medium of claim 16, including executing an exception policy wherein the execution response is an exception response.

18. The computer readable medium of claim 13, wherein the event is a scheduled event, wherein the scheduled event occurs at a predetermined time.
